(19) United States
(12) Patent Application Publication
(10) Pub. No.: US 2024/0384833 A1
(43) Pub. Date: Nov. 21, 2024

(54) SINK CADDY

(71) Applicant: Dorai Home, Inc., West Valley City, UT (US)

(72) Inventors: Jason Klug, Salt Lake City, UT (US); Isabella Gonos, Salt Lake City, UT (US); Kelsey O'Callaghan, Salt Lake City, UT (US); Edward Packer, Salt Lake City, UT (US)

(73) Assignee: Dorai Home, Inc., West Valley City, UT (US)

(21) Appl. No.: 18/667,625

(22) Filed: May 17, 2024

Related U.S. Application Data
(63) Continuation-in-part of application No. 29/892,586, filed on May 19, 2023.
(60) Provisional application No. 63/467,918, filed on May 19, 2023.

(51) Int. Cl. F16M 11/22; A47J 47/16; A47J 47/20; F26B 5/16

(52) U.S. Cl. CPC F16M 11/22; A47J 47/16; A47J 47/20; F26B 5/16; F16M 2200/08

(57) ABSTRACT

In some implementations, a caddy includes an absorbent slab and a base. The absorbent slab may be characterized by a top slab surface, a bottom slab surface, and a thickness. The absorbent slab may include diatomaceous earth and may have an aperture that extends from the bottom slab surface into the thickness. The base may be characterized by a length and a width and may include a top base surface and a bottom base surface, a first support rail and a second support rail, a first end support rail and a second end support rail, a retention nub that extends away from the top base surface, and a plurality of feet that extend away from the bottom base surface.

### CROSS-REFERENCE TO RELATED APPLICATIONS

This application claims priority to U.S. Patent Application 63/467,918, titled “Sink Caddy,” filed May 19, 2023; and U.S. patent application Ser. No. 29/892,586, titled “Sink Caddy,” filed May 19, 2023. This application incorporates the entire contents of the foregoing applications herein by reference.

### TECHNICAL FIELD

Various implementations relate generally to caddies for supporting articles that may be wet.

### BACKGROUND

Some articles may frequently be wet or exposed to moisture, and it may be beneficial for such articles to be stowable where they can dry out without creating a mess in their vicinity and in a manner that does not foster growth of mildew or mold. Kitchen items, in particular—such as soap dispensers, scrub brushes, sponges, etc. —may be frequently exposed to water.

### SUMMARY

Disclosed herein is a caddy that may support wet articles while they are drying—such as, for example, soap dispensers, scrub brushes, sponges, etc. An exemplary caddy may include an absorbent slab that accelerates drying of articles placed on the caddy. In some implementations, the absorbent slab comprises diatomaceous earth.

In some implementations, a caddy includes an absorbent slab and a base. The absorbent slab may be characterized by a top slab surface, a bottom slab surface, and a thickness. The absorbent slab may include diatomaceous earth and may have an aperture that extends from the bottom slab surface into the thickness. The base may be characterized by a length and a width and may include a top base surface and a bottom base surface, a first support rail and a second support rail, a first end support rail and a second end support rail, a retention nub that extends away from the top base surface, and a plurality of feet that extend away from the bottom base surface. The base may be made of a silicone having a Shore A durometer of about 45.

The first and second support rails may extend along the length. The first and second end support rails may connect to each of the first and second support rails at opposite ends of the length. The plurality of feet may be configured such that when the base is disposed on a horizontal surface on the plurality of feet, the bottom base surface is spaced apart from the horizontal surface. In some implementations, the first and second support rails are parallel to each other and the first and second end support rails are parallel to each other and perpendicular to the first and second support rails.

The retention nub may be configured to extend into the aperture to form a compression fit to thereby couple the absorbent slab to the base. The retention nub may be shaped as a truncated cone and may further include a plurality of discrete extensions that radiate out from the nub.

The absorbent slab may further include an open channel disposed below a top surface of the absorbent slab. The absorbent slab may have a concave top surface configured to direct water to the channel when the caddy is disposed on a horizontal surface.

### BRIEF DESCRIPTION OF THE DRAWINGS

FIG. 1 is an exploded view of an exemplary caddy.

FIG. 2 is a bottom perspective view of the exemplary caddy shown in FIG. 1.

FIG. 3 is a bottom perspective view of the underside of an exemplary absorbent slab.

FIG. 4 illustrates an exemplary retention nub.

### DETAILED DESCRIPTION

Disclosed herein is a caddy 101 that may support wet articles while they are drying—such as, for example, soap dispensers, scrub brushes, sponges, etc. An exemplary caddy 101 may include an absorbent slab 104 that accelerates drying of articles placed on the caddy 101. In some implementations, the absorbent slab 104 comprises diatomaceous earth.

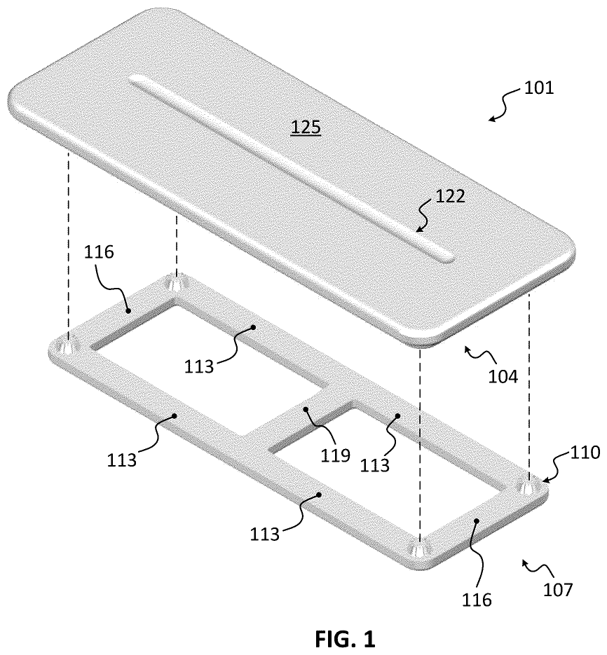

FIG. 1 is an exploded view of an exemplary caddy 101. In some implementations, as shown, the caddy 101 includes an absorbent slab 104, and a base 107. The base 107 may include retention nubs (such as the retention nub 110) that interface with corresponding cavities (e.g., cavity 137, shown in FIG. 3) to form a compression fit and couple the absorbent slab 104 to the base 107.

In some implementations, the absorbent slab 104 comprises diatomaceous earth and is configured to rapidly absorb water that comes into contact with its surface and wick that water throughout its volume such that it can evaporate from its surface area. To further aid in absorption and wicking of water coming into contact with a surface of the absorbent slab 104, some implementations may include a channel 122 to collect water that may otherwise pool and/or run off a top surface 125. In some implementations, the top surface 125 may be concave along a length, such that water naturally runs into the channel 122 (when the caddy 101 is placed on a level surface).

The base 107 may include support rails 113 that extend along a substantial portion of the length of the absorbent slab 104. (As used herein, “substantial” may mean within at least 20% or 50% or 90% of a nominal value). End rails 116 may couple parallel support rails 113; and in some implementations, one or more cross rails 119 may provide further support (e.g., in the middle, as shown, or at intervals for a long caddy).

In some implementations, the base 107 comprises a material that is different from the absorbent slab 104. For example, the base 107 may comprise a silicone having a Shore A durometer value of between 25 and 65. In some implementations, the base 107 comprises a silicone having a Shore A durometer value of about 45. (As used herein, “about” may mean within 1%, 2%, 5%, 10%, 20%, 50% or 100% of a nominal value.) In some implementations, the material and hardness is selected to have a sufficient coefficient of friction relative to common countertop materials (e.g., granite, quartz, laminate, etc.), such that the base 107 resists lateral movement when placed on such countertop materials.

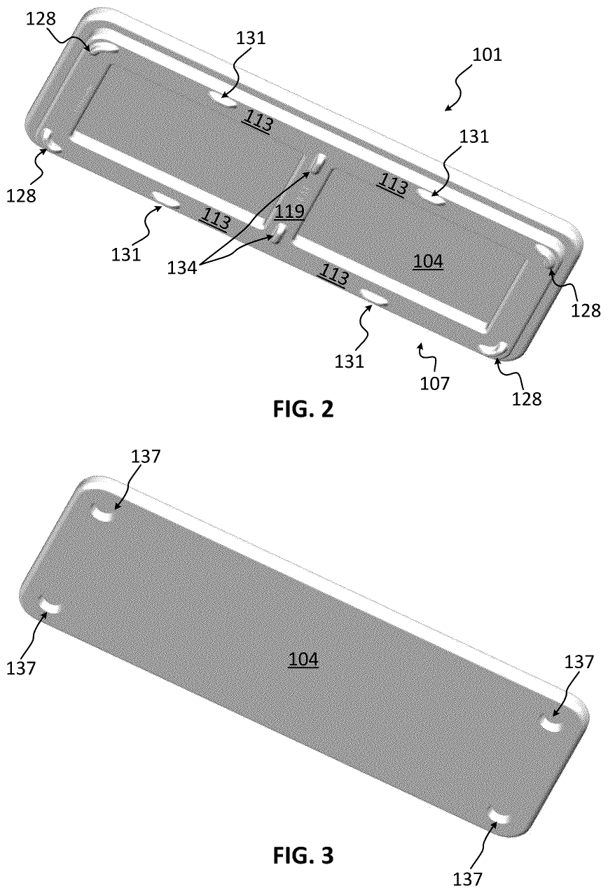

FIG. 2 is a bottom perspective view of the caddy 101 in an assembled configuration—in which the absorbent slab 104 is coupled to the base 107. As shown, a bottom portion of the base 107 may include a plurality of legs, including, for example, corner legs 128, side legs 131 (e.g., on the side support rails 113) and intermediate or middle legs 134 (e.g., on any cross rails 119 that may be present). In other implementations, more or fewer legs may be employed. In general, regardless of the number and location of the legs, the legs may be disposed to elevate the base 107 above a surface on which it is disposed, such that air can readily circulate around a majority of the surface of the absorbent slab 104 (e.g., to accelerate evaporation of water that is absorbed by the absorbent slab 104, from its surface).

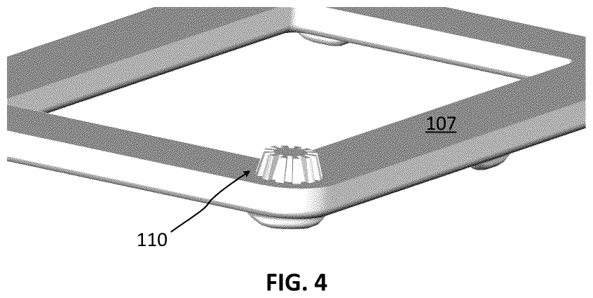

FIG. 3 illustrates exemplary cavities 137 that may be disposed in an underside of the absorbent slab 104 to facilitate its coupling with the base 107. FIG. 4 illustrates an exemplary corresponding nub 110 that may be configured to interface with a cavity 137. In some implementations, the nub 110 may be in the shape of a cone or truncated cone, to simplify location and indexing of the base 107 relative to the absorbent slab 104 and to provide a progressively tighter coupling as the absorbent slab 104 (specifically, the cavities 137 in the absorbent slab 104) more fully receive the nubs 110. In some implementations, a nub 110 further comprises a plurality of discrete “wings” or extensions that facilitate a tight compression fit with a corresponding cavity 137. Other forms of coupling the base 107 and absorbent slab 104 are contemplated, such as, for example, adhesives, threaded connections, through-hole connections, and other forms of compression fittings.

Several implementations have been described with reference to exemplary aspects, but it will be understood by those skilled in the art that various changes may be made and equivalents may be substituted for elements thereof without departing from the contemplated scope. For example, a base may have more than one cross rail, or the cross rail may be omitted. More than two support rails may be employed. Materials other than silicone may be employed for the base (e.g., natural or synthetic rubbers, plastics, polymers, woods, etc.). One or more channels may be disposed in the top of an absorbent slab. Some absorbent slabs may omit a channel. Channels may be straight or patterned in another manner. Various composites that include diatomaceous earth may be employed. Caddies may be dimensioned and shaped in other ways. More or fewer legs may employed. Many other variations are possible, and modifications may be made to adapt a particular situation or material to the teachings provided herein without departing from the essential scope thereof.

What is claimed is:

1. A caddy comprising:
an absorbent slab characterized by a top slab surface, a bottom slab surface, and a thickness; the absorbent slab comprising diatomaceous earth and having at least one aperture that extends from the bottom slab surface into the thickness; and
a base characterized by a length and a width, and comprising (i) a top base surface and a bottom base surface; (ii) a first support rail and a second support rail, the first and second support rails extending along the length; (iii) a first end support rail and a second end support rail, the first and second end support rails connecting to each of the first and second support rails at opposite ends of the length; (iv) at least one retention nub that extends away from the top base surface; and (v) a plurality of feet that extend away from the bottom base surface, such that when the base is disposed on a horizontal surface on the plurality of feet, the bottom base surface is spaced apart from the horizontal surface;
wherein the at least one retention nub is configured to extend into the at least one aperture to form a compression fit to thereby couple the absorbent slab to the base.

2. The caddy of claim 1, wherein the absorbent slab further comprises an open channel disposed below a top surface of the absorbent slab.

3. The caddy of claim 1, wherein the absorbent slab has a concave top surface configured to direct water to the channel when the caddy is disposed on a horizontal surface.

4. The caddy of claim 1, wherein the first and second support rails are parallel to each other and the first and second end support rails are parallel to each other and perpendicular to the first and second support rails.

5. The caddy of claim 1, wherein the at least one retention nub is shaped as a truncated cone.

6. The caddy of claim 5, wherein the at least one retention nub further comprises a plurality of discrete extensions that radiate out from the nub.

7. The caddy of claim 1, wherein the base comprises silicone having a Shore A durometer of about 45.
